(19) United States
(12) Patent Application Publication
(10) Pub. No.: US 2010/0026017 A1
(43) Pub. Date: Feb. 4, 2010

(54) PORTABLE DOOR LOCK

(76) Inventor: Francisco Ramos III, Oberlin, OH (US)

Correspondence Address: FRED ZOLLINGER III, P.O. BOX 2368, NORTH CANTON, OH, 44720, US

(21) Appl. No.: 12/503,197

(22) Filed: Jul. 15, 2009

Related U.S. Application Data
(60) Provisional application No. 61/086,003, filed on Aug. 4, 2008.

(51) Int. Cl. E05C 19/18

(52) U.S. Cl. 292/295

(57) ABSTRACT

A portable door lock has a threaded locking bar having a hooked end that engages the hole of a strike plate. A block and a locking nut are carried by the bar. The locking nut is movable between unlocked and locked positions. When in the unlocked position, the locking nut may slide back and forth along the bar. When in the locked position, the thread of the locking nut engages thread portions of the threaded bar to prevent the locking nut from sliding along the bar.

### CROSS REFERENCE TO RELATED APPLICATION

This application claims the benefit of U.S. Provisional Patent application 61/086,003 filed Aug. 4, 2008; the disclosures of which are incorporated herein by reference.

### BACKGROUND OF THE INVENTION

1. Field of the Invention

The present invention generally relates to locks and, more particularly, to a portable door lock that may be used with different doors and door jambs. Specifically, the present invention relates to a portable door lock that latches into the strike plate of a door jamb and engages the inner surface of a door to prevent the door from being opened.

2. Brief Description of the Prior Art

A variety of portable door locks are known in the art. One category of these portable door locks includes locks that use a hooked-end thin bar that is placed in the opening of the strike plate of a door jamb. A portion of the thin bar projects out away from the inner surface of the door to be locked perpendicular to the inner surface of the door. A blocking device engages the projecting portion of the thin bar. The blocking device extends between the inner surface of the door and the door jamb to hold the door closed. If one attempts to open the door from the outside, the door engages the blocking device which, in turn, engages the thin bar. The thin bar is secured to the strike plate to resist the opening force being applied to the door. Examples of these types of portable door locks include those disclosed in U.S. Pat. Nos. 1,234,158, 3,039,806, 3,416,333, 4,429,913, 4,471,981, 5,480,200, and 5,836,626.

### SUMMARY OF THE INVENTION

The invention provides a portable door lock having a threaded bar having a hook that engages the hole of a strike plate. A block and a locking nut are carried by the bar. The locking nut is movable between unlocked and locked positions. When in the unlocked position, the locking nut may slide back and forth along the bar. When the lock is used, the user pushes the locking nut and block against the door before moving the locking nut to the locked position. When in the locked position, the thread of the locking nut engages at least one of the thread portions of the threaded bar to prevent the locking nut from sliding along the bar. The thread of the locking nut may engage a plurality of thread portions on the threaded bar to ensure a secure connection between the locking nut and the threaded bar. When the locking nut is rotated to its locked position, it moves slightly toward the door because of the pitch of the threads thus even more securely positioning the block and locking nut.

In another configuration, the bar has teeth and the locking nut has a slot that engages the teeth. The teeth and slot do not necessarily have to be pitched like a thread in order to function.

The invention also provides a configuration wherein the locking nut described above includes stop pins that stop the locking pin precisely in its unlocked position.

The invention also provides a configuration wherein the locking nut described above includes magnets that connect the locking nut to the block so that the two move together while allowing the nut to rotate against the block.

The invention also provides a configuration wherein an extension may be added to a portion of the portable door lock so that the lock will be evenly seated on a door frame having raised molding next to the door.

The invention further provides a method for using a portable door lock to lock a door including the steps of inserting a hooked end of a locking bar into an opening defined by the doorjamb and then closing the door. A lock nut in an unlocked position is then slid along the locking bar until the lock nut abuts the door and doorjamb. A block separate from the lock nut also may be moved along with the lock nut. The lock nut is then rotated to a locked position to secure the lock and to prevent the door from being opened.

The invention further provides a lock that is sized to be portable. The overall lock may fit in one's hand or pocket so that it may be easily transported to different locations for use.

### BRIEF DESCRIPTION OF THE DRAWINGS

FIG. 1 is a perspective view of one exemplary configuration of the portable door lock with the nut in the locked position.

FIG. 2 is a section view taken along line 2-2 showing the locked position of the nut.

FIG. 3 is a perspective view similar to FIG. 1 showing the unlocked position of the nut.

FIG. 4 is a section view taken along line 4-4 showing the unlocked position of the lock.

FIG. 5 is a section view taken along line 5-5 showing the magnets holding the nut to the blocking member.

FIG. 6 is a schematic top view of the portable lock in use locking a door closed.

FIG. 7 is a perspective view of an extension.

FIG. 8 is a schematic top view similar to FIG. 6 showing the extension in use.

The drawings are not to scale. Similar numbers refer to similar elements throughout the specification.

### DESCRIPTION OF THE PREFERRED EMBODIMENT

An exemplary configuration of the portable lock of the invention is indicated generally by the numeral 10 in the accompanying drawings. Lock 10 generally includes a toothed or threaded locking bar 12, a block 14, and an internally slotted or threaded locking nut 16. Lock 10 also may include an optional handle 18. In an optional configuration of lock 10, block 14 is integrated with locking nut 16 as a single integral piece such that portions of locking nut 16 function as block 14. In another optional configuration, an extension 80 is provided that allows one portion of the lock to be extended to allow lock 10 to squarely sit on a door frame with raised molding.

As shown in FIG. 6, lock 10 may be used to lock a door 20 closed by engaging bar 12 with the opening defined by strike plate 22 and positioning block 14 across the inner surface of door 20 and the door jamb 24. When one applies an opening force to door 20, the inner surface of door 20 engages block 14 urging it against locking nut 16 away from doorjamb 24. When in its locked position, locking nut 16 engages at least one or a plurality of the teeth or thread portions 48 of threaded bar 12 to prevent locking nut 16 from sliding along bar 12. In the exemplary configuration, locking nut 16 is internally threaded and thread portions 48 of bar 12 cooperate to define a thread that threadedly engages locking nut 16 so that locking nut 16 will rotatably thread onto bar 12. The threaded connection allows nut 16 to be further tightened against door 20 when nut 16 is rotated from its unlocked position to its locked position. The opening force of door 20 is thus transferred to bar 12 which is secured to jamb 24 at strike plate 22. This arrangement resists the opening force and prevents door 20 from being opened.

The user may remove lock 10 from door 20 by rotating locking nut 16 to its unlocked position wherein opposed notches 30 of locking nut 16 are aligned with the bar 12 so that locking nut 16 may slide along bar 12. Once locking nut 16 is in the unlocked position, the user may slide locking nut 16 along bar 12 away from door 20 to allow door 20 to swing open. Lock 10 then may be removed from jamb 24. In one configuration, locking nut 16 of lock 10 includes at least one magnet 32 that holds block 14 against locking nut 16 so that block 14 is pulled away from door 20 when the user moves locking nut 16 away from door 20. Two magnets 32 as shown provide a smooth operation. Although magnet 32 holds block 14 against locking nut 16, magnet 32 allows locking nut 16 to rotate back and forth between locked and unlocked positions.

One exemplary configuration of lock 10 is described in order to provide the best mode of lock 10 now understood by the inventor. Other configurations may be assembled without departing from the invention. In the described configuration, bar 12 is made from steel bar that is one inch wide, one-eighth inch thick and a total (including bends) of six and three-quarter inches long. Bar 12 includes a hooked first end 40 and a second end 42. One inch of bar 12 is bent at a ninety degree angle adjacent second end 42 so that handle 18 is parallel to door 20 when lock 10 is in use.

Handle 18 is also made from a steel bar of the same width and thickness as bar 12 while having a length of three inches. Handle 18 is connected to the one inch bent portion of bar 12 adjacent second end 42 with a nut and bolt assembly 44 that is disposed through a pair of three-eighth inch holes defined in bar 12 and handle 18. A half-inch portion 46 of handle 18 may be bent at a ninety degree angle to define a hand grip area between portion 46 and bar 12.

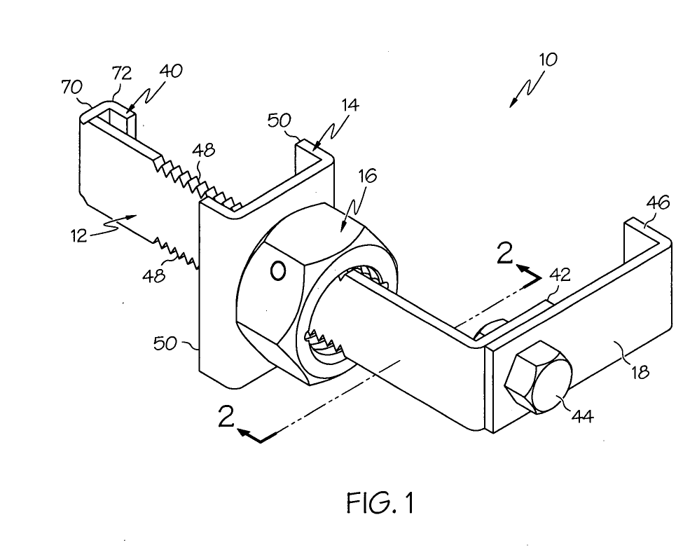

The position of handle 18 may be adjusted in the event a structure next to the door prevents handle 18 from extending outwardly to the side as shown in FIG. 1. Handle 18 may be adjusted to point up or down as desired. In another configuration of the invention, handle 18 is retained in its position by a spring-loaded catch that allows position adjustments after the user depresses the catch against a spring. This configuration allows the position of handle 18 to be adjusted without the use of tools. The spring-loaded catch allows handle 18 to be adjusted 90 degrees up or down from the position of FIG. 1 for a full 180 degree adjustment.

Bar 12 has a toothed or threaded portion along its shank that is two and three-quarter inches long and is disposed two and three-quarter inches from second end 42 of bar 12. The thread portions of this portion 48 are configured to threadedly engage a one inch nut (locking nut 16) having 1-8 threading (8 threads per inch). The thread portions of the threaded portion 48 are disposed along the upper and lower edges of bar 12. The thread portions are angled and staggered in the same manner as a thread designed to engage locking nut 16. In another configuration, bar 12 includes teeth configured to engage slots defined by nut 16 in a non-threaded configuration.

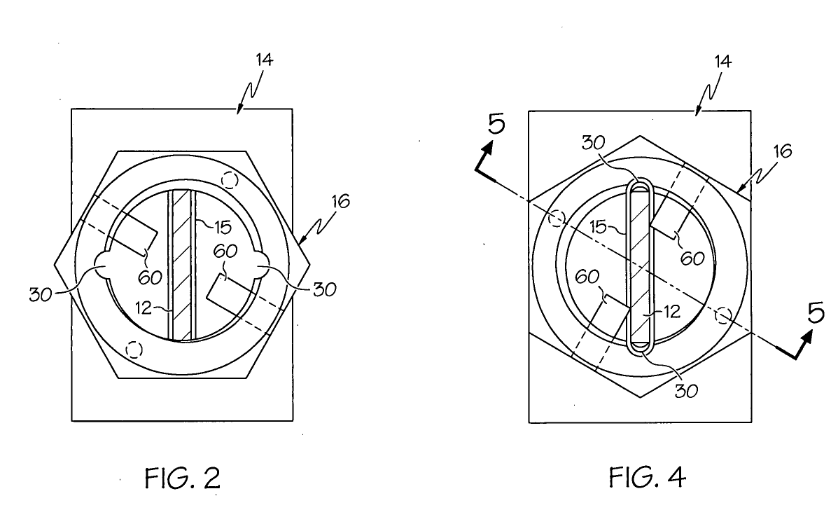

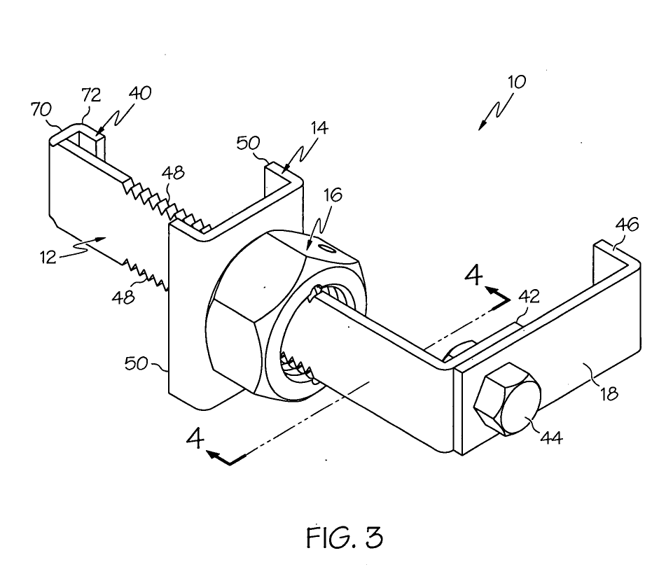

Block 14 is also fabricated from one-eighth inch steel plate. Block 14 may be two and a sixteenth inch tall. Block 14 includes a pair of three-quarter inch feet 50 that engage door 20 and jamb 24 when lock 10 is in use as shown in FIG. 6. Feet 50 also provide space for the strike plate to protrude from the door. Block 14 defines a slot 15 (FIGS. 2 and 4) that is slightly larger (wider and thicker) than the cross section of bar 12 so that block 14 may easily slide along bar 12. The slot may be centrally located. The slot may be one and a sixteenth inch tall and slightly more than one-eighth inch wide.

As noted above, locking nut 16 may be a one inch nut having a single continuous internal thread that threadedly engages threaded portion 48 of bar 12. The threaded engagement between locking nut 16 and bar 12 prevents locking nut 16 from sliding along bar 12. As also noted above, locking nut 16 defines a pair of opposed notches 30 where the thread of locking nut 16 is eliminated. Notches 30 are configured to be wider and thicker (about a 1/16 inch larger) than the teeth on bar 12 to allow locking nut 16 to slide along threaded portion 48 of bar 12 when notches 30 are aligned with the upper and lower edges of bar 12 as shown in FIG. 4.

A pair of stop pins 60 are carried by locking nut 16 and project into the central opening of locking nut 16. Stop pins 60 are positioned to allow locking nut 16 to rotate at least one-quarter turn. In FIG. 2, locking nut 16 is in the locked configuration with bar 12 threadedly engaging locking nut 16. Although FIG. 2 does not depict pins 60 engaging bar 12 when locking nut 16 is in the locked position, pins 60 may be positioned to engage bar 12 as soon as locking nut 16 is turned one-quarter turn to the right from its unlocked position. In the exemplary configuration, at least one stop pin 60 engages bar 12 when locking nut 16 is turned to the left in order to stop and align locking nut notches 30 in the unlocked position thus allowing locking nut 16 and block 14 to slide freely along bar 12 as shown in FIG. 4. Turning locking nut 16 to the left until it stops thus places locking nut 16 in the unlocked position. Locking nut 16 is moved back to the locked position by rotating locking nut 16 back to the right.

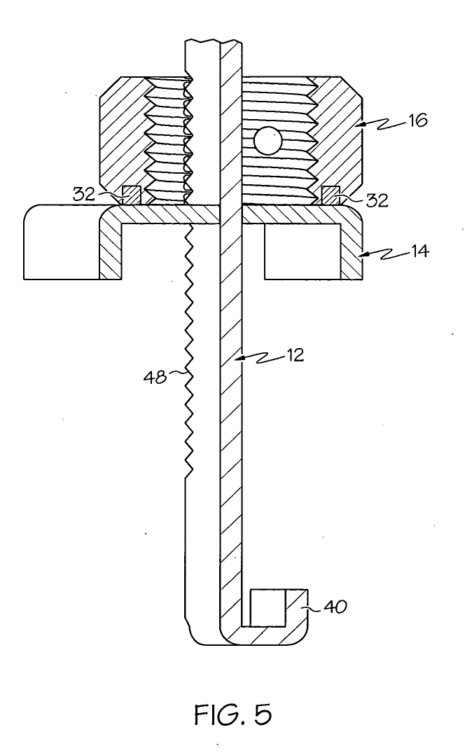

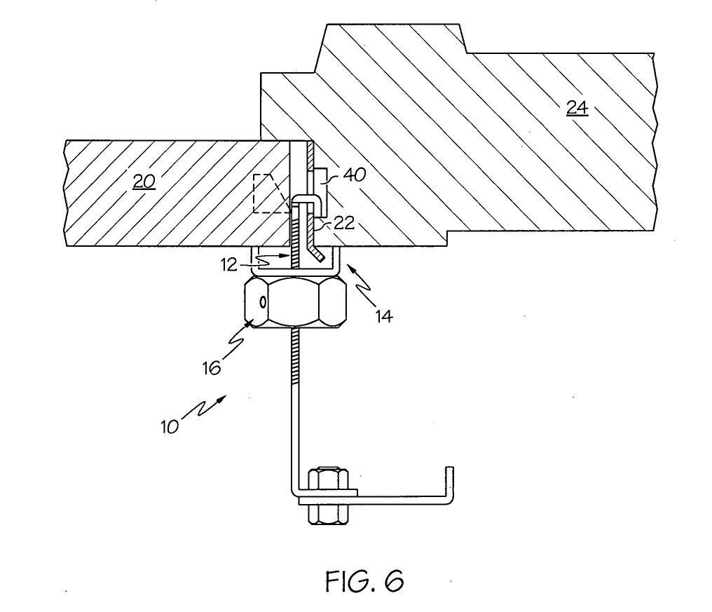

Locking nut 16 also carries at least one magnet 32. In the exemplary configuration, locking nut 16 carries a pair of magnets 32 that hold locking nut 16 and block 14 together as shown in FIG. 5. Magnets 32 allows locking nut 16 to rotate with respect to block 14 while also causing block 14 to slide along bar 12 with locking nut 16. Magnets 32 are carried in recesses so that they are flush with the outer surface of locking nut 16.

First hooked end 40 of bar 12 is configured to fit within a standard opening in a typical strike plate 22. In the exemplary configuration, hooked end 40 has a first arm 70 and a second arm 72 that are each seven-eighth inches wide. The outside length dimension of first arm 70 is a half inch with the outside length dimension of second arm 72 being three-eighth inch. This provides a one-quarter inch gap between the inner surface of second arm 72 and the main portion of bar 12. This configuration allows end 40 to be securely retained within strike plate 22 when lock 10 is in use.

Lock 10 is used by opening door 20 to expose strike plate 22. Hooked end 40 of lock 10 is inserted into strike plate 22 as shown in FIG. 6. Door 20 is then closed as the user holds lock 10 in place. Once door 20 is closed, the user moves locking nut 16 to the unlocked position so that locking nut 16 can slide along bar 12. The user then pushes locking nut 16 and block 14 toward door 20 and doorjamb 24 until block 14 tightly engages door 20 and jamb 24. The user then rotates locking nut 16 to the right so that the thread of locking nut 16 engages the thread portions 48 of bar 12 and further tightens locking nut 16 against door 20. The user may then release lock 10 and door 20 is locked closed. When the user wishes to unlock door 20, the steps above are reversed to remove lock 10 from door 20.

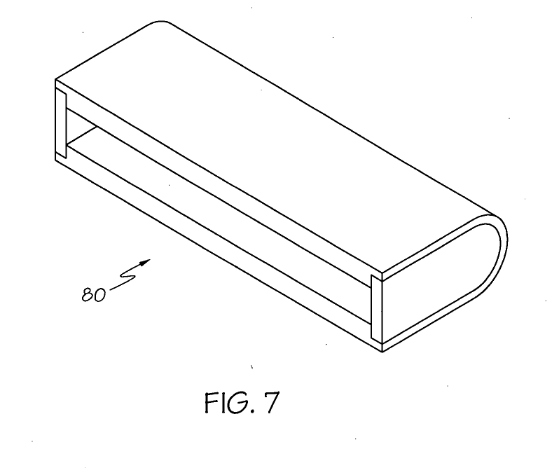

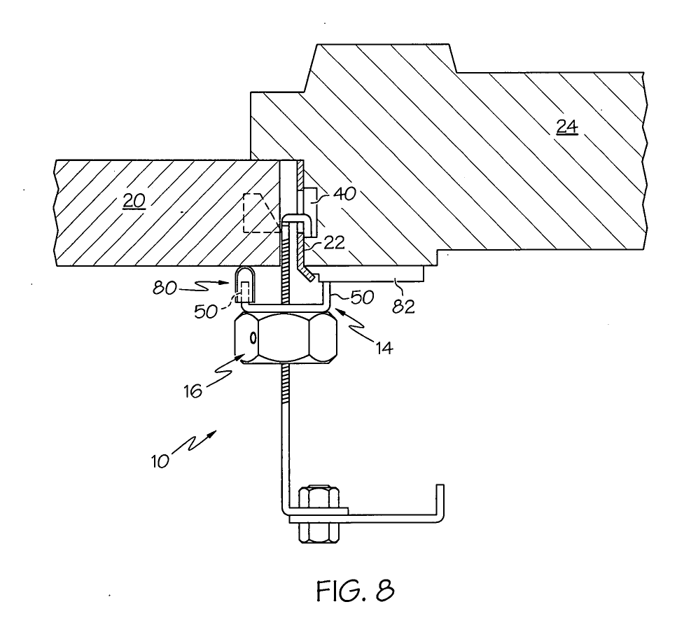

FIG. 7 shows an extension 80 that is used with block 14 when jamb 24 is disposed outwardly of door 20 such as when a piece of molding 82 is disposed on jamb 24 on shown in FIG. 8. Extension 80 is in the form of a five-sided box that is frictionally received onto the end of foot 50 as shown in FIG. 8. Extension 80 may be fabricated from the same material as block 14. Extension 80 is longer than foot 50 so that the open end of extension 80 abuts the inner surface of the main body of block 14 that extends between feet 50. Extension 80 is used by sliding extension 80 onto the foot 50 of block 14 that engages door 20 to effectively lengthen foot 50 so that block 14 rests more squarely in place when in the locked position. Extension 80 thus completely surrounds the end of foot 50 so that it will not readily fall off foot 50 or be shaken loose from foot 50 if door 20 is subjected to a series of blows in an attempt to defeat lock 10. Different extensions 80 may be provided in different lengths for use with different molding thicknesses.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the description and illustration of the invention is an example and the invention is not limited to the exact details shown or described.

1. A portable door lock for use between a door and a doorjamb; the portable door lock comprising:
a block adapted to extend between door and door jamb; the block defining an opening;
a locking bar having a hooked end and a shank; the shank extending through the opening in the block;
the shank defining a threaded portion;
a lock nut defining a threaded opening; the lock nut carried by the shank;
the lock nut defining a notch; and
the lock nut being rotatable between locked and unlocked positions; the threaded portion of the shank threadedly engaging the thread of the lock nut when the lock nut is in the locked position; the threaded portion of the shank disposed in the notch when the lock nut is in the unlocked position such that lock nut may slide along shank.

2. The lock of claim 1, further comprising a first magnet that holds the lock nut against the block but allows the lock nut to be rotated with respect to the block between the locked and unlocked positions of the lock nut.

3. The lock of claim 2, further comprising a second magnet that holds the lock nut against the block but allows the lock nut to be rotated with respect to the block between the locked and unlocked positions of the lock nut; the first and second magnets being disposed on opposite sides of the shank.

4. The lock of claim 3, wherein the first and second magnets are carried by the lock nut.

5. The lock of claim 1, further comprising a stop pin carried by the lock nut; the stop pin engaging the shank to stop the rotation of the lock nut when the lock nut is disposed in the unlocked position with respect to the shank.

6. The lock of claim 1, further comprising a handle connected to the shank.

7. The lock of claim 6, wherein the handle is configurable between at least first and second positions with respect to the shank.

8. The lock of claim 1, wherein the hooked end has a first arm disposed perpendicular to the shank and a second arm disposed perpendicular to the first leg.

9. The lock of claim 8, wherein the shank has a width and the widths of the first and second arms of the hooked end are less than the width of the shank.

10. The lock of claim 1, wherein the block includes a pair of legs; the lock further comprising an extension carried by one of the legs.

11. The lock of claim 10, wherein the extension is in the form of a five-sided box that frictionally receives the leg of the block.

12. The lock of claim 11, wherein the block has a main body portion having an inner surface adapted to face the door when the lock is installed; the extension abutting the inner surface of the main body of the block.

13. A portable door lock for use between a door and a door jamb; the portable lock comprising:
a block adapted to extend between door and door jamb; the block defining an opening;
a locking bar having a hook end and a shank; the shank extending through the opening in the block;
the shank defining a threaded portion;
a lock nut defining a threaded opening; the lock nut carried by the shank; and
a magnet holding the lock nut to the block but allowing the lock nut to rotate with respect to the block.

14. The lock of claim 13, further comprising a second magnet that holds the lock nut against the block but allows the lock nut to be rotated with respect to the block between the locked and unlocked positions of the lock nut; the first and second magnets being disposed on opposite sides of the shank.

15. The lock of claim 14, wherein the first and second magnets are carried by the lock nut.

16. The lock of claim 13, wherein the hooked end has a first arm disposed perpendicular to the shank and a second arm disposed perpendicular to the first leg.

17. The lock of claim 16, wherein the shank has a width and the widths of the first and second arms of the hooked end are less than the width of the shank.

18. The lock of claim 13, wherein the lock nut defines a notch; the lock nut being rotatable between locked and unlocked positions; the threaded portion of the shank threadedly engaging the thread when the lock nut is in the locked position; the threaded portion disposed in the notch when the lock nut is in the unlocked position such that lock nut may slide along shank.

19. A portable door lock for use between a door and a door jamb; the portable door lock comprising:
a block adapted to extend between door and door jamb; the block defining an opening;
a locking bar having a hooked end and a shank; the shank extending through the opening in the block;
the shank defining at least one tooth;
a lock nut defining a slotted opening; the lock nut carried by the shank;
the lock nut defining a notch; and
the lock nut being rotatable between locked and unlocked positions; the tooth of the shank threadedly disposed in the slot of the lock nut when the lock nut is in the locked position; the tooth of the shank disposed in the notch when the lock nut is in the unlocked position such that lock nut may slide along shank.
